(19) United States
(12) Patent Application Publication
(10) Pub. No.: US 2009/0300816 A1
(43) Pub. Date: Dec. 10, 2009

(54) Control panels for sportswear

(76) Inventors: Kenneth C. Brito, Giridara (LK); K. G. Gayan Yapa, Giridara (LK); K. W. M. Madumantha Kandepola, Giridara (LK)

Correspondence Address: MORGAN LEWIS & BOCKIUS LLP, 1111 PENNSYLVANIA AVENUE NW, WASHINGTON, DC, 20004, US

(21) Appl. No.: 12/155,536

(22) Filed: Jun. 5, 2008

(51) Int. Cl. A41D 7/00; A41D 27/00; B32B 38/04

(52) U.S. Cl. 2/67; 2/243.1; 156/73.4; 156/73.3; 156/263

(57) ABSTRACT

A garment has an inner layer for providing support and control to a wearer's body. In addition, a method for making such a garment is described. The inner layer is formed by bonding control liners to a main panel. The inner layer may then be attached at its edges to the edges of the outer layer of the garment.

### FIELD AND BACKGROUND OF INVENTION

The present invention is associated with the field of swimwear and sportswear, and particularly to an innovative and useful method of achieving different moduli of elasticity in different areas of a fabric panel.

Swimwear and sportswear are often made of material that does not provide much support or control of a wearer's body. However, some areas of the body require more support than other areas. Attempts to solve the problem include forming a multi-layered fabric laminate as a single main piece for fabrication of garments. The multi-layered fabric is then cut into a panel size to fabricate a garment. However, this often results in unsightly bulges and discontinuities visible on the exterior of the clothes as they are worn, and does not present a smooth exterior appearance. Consequently, there is a need for a method of varying the moduli of elasticity of various areas of clothing that does not produce such unsightly features.

### SUMMARY OF INVENTION

In one embodiment of the present invention, garments and methods of making garments having varying moduli of elasticity in specific areas of the garments are disclosed, such as for swimwear and sportswear garments. This feature may be achieved by providing separate inner and outer layers of fabric for the garment. In that embodiment, the inner layers, or liner layers, may be bonded together only in specific areas in which control and support are required.

In another embodiment, the outer layers of the garment are not bonded to the liner layers and are allowed to “float” over the liner layers. According to this embodiment, the garment may include body enhancing features such as lifting and control in certain areas, while maintaining a natural appearance and the original softness and texture of the exterior of the garment. The required shapes of control panels may be cut and then applied to a main inner panel. Accordingly, adhesive and fabric use may be reduced compared with creating a fabric laminate and cutting panels thereafter.

The various features of novelty which characterize this invention are pointed out with distinctiveness in the claims annexed to and forming part of this disclosure. For a better understanding of the invention, its operating advantages, and specific objectives attained by its use, reference is made to the accompanying drawings and descriptive matter in which a preferred embodiment of the invention is illustrated.

### BRIEF DESCRIPTION OF THE DRAWINGS

FIG. 1 is a perspective view of a control panel being formed by adding an adhesive to a control liner.

FIG. 2 is a perspective view of a control panel formed in FIG. 1 being applied to a main panel to form an inner layer of a garment.

FIG. 3 is a perspective view of the inner layer of a garment formed by the application of a control panel to a main panel as shown in FIG. 2.

FIG. 4 is a cross-sectional view of a garment according to the present invention.

### DESCRIPTION OF THE PREFERRED EMBODIMENTS

As used herein, the term facing refers to either side of a piece of fabric. As is known to persons of ordinary skill in the art, fabrics have what is known as a technical front and a technical back. The technical front and the technical back of a piece of fabric may be smooth or textured. The terms technical front and technical back refer to the front and back of the fabric as it is made on a machine, and do not necessarily correspond to the front and back of a fabric as it is incorporated into a fabric laminate. In fabric laminates according to the present invention, either the technical front or technical back of one layer of fabric may be adhered to the technical front or technical back of another layer of fabric. The particular arrangement depends on a number of considerations, including which two sides of the two fabric layers are most compatible when being adhered to each other.

In the present invention, an inner layer of fabric (“liner layer”) may be attached to the inside of an outer layer of a garment such as a women's bathing suit by attaching along the edges of the inner layer (also referred to as “liner layer”). In one aspect, it may be attached only along the edges. This may allow the outer layers of the garment to “float” over the liner layer, maintaining a smoother appearance and softer feel of the exterior of the garment. The edges of the liner layer may be applied to the outer layer of a garment by various methods, including but not limited to sewing, using adhesives, and hot melting. In any event, the edges of the liner layer may be typically attached to the outer layer of the garment.

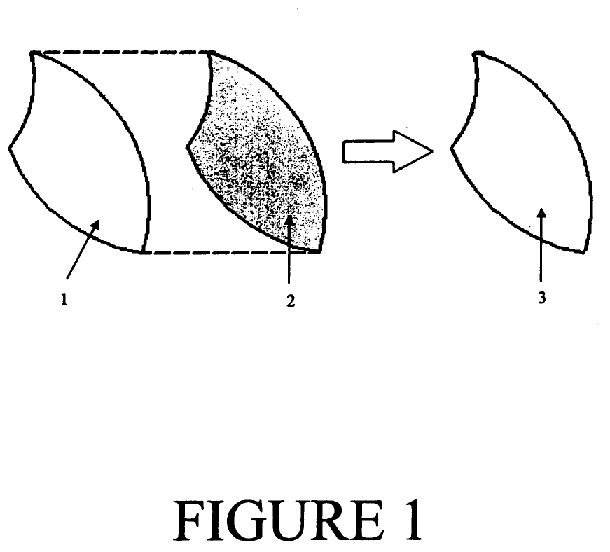

FIG. 1 shows an adhesive 2 being applied to a control liner 1 to create a control panel 3. The control liner 1 may be first cut into a specific shape that will provide control or support when applied to a liner layer. The control liner 1 may be cut using blades, lasers, heat, dye cutting, ultrasonic cutting, or any other method known in the art. The control panel 3 is shown as control liner 1 bonded (or semi-bonded) to the control liner 1 with an adhesive layer 2. The adhesive layer 2 may be applied either in liquid form or in solid (paper-like) form. Adhesives used in adhesive layer 2 may include, but are not limited to, thermoplastic and thermosetting adhesives. Those adhesives may be in web, sheet, dot lamination, or liquid form.

As an alternative to adhesives, control panel 3 may be bonded to control liner 1 by heat pressing, ultrasonic bonding, or any other method of bonding recognized in the art.

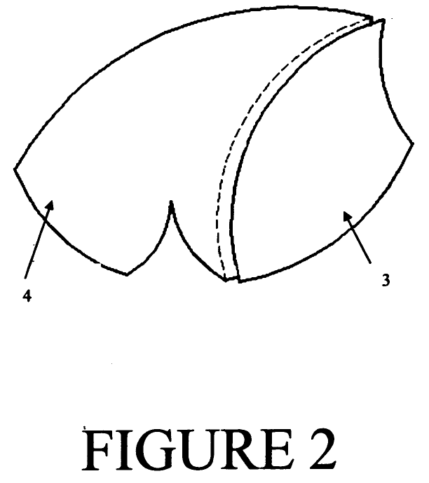

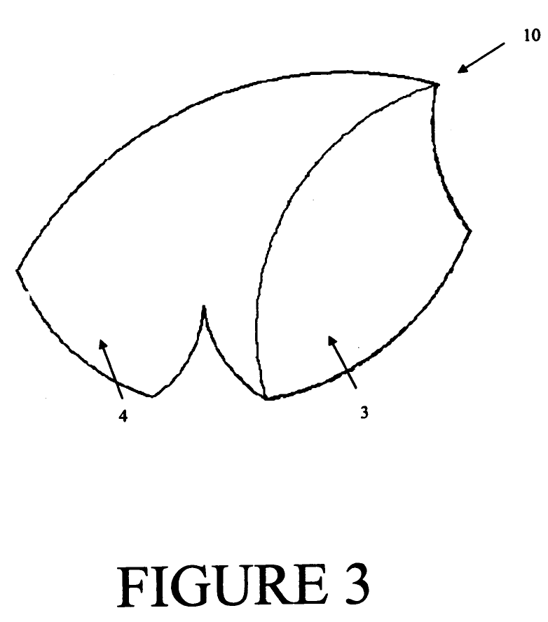

FIG. 2. shows control panel 3 being placed on a specific area of the main panel 4 of a liner layer. FIG. 3 displays the liner layer 10 formed by bonding or attaching the control panel 3 to the main panel 4. Control panels may be of any size relative to main panels, and may be placed on any area of the liner layer where support and control are required, including at the edges of the liner layer. Multiple control panels may be placed on a single liner layer where support and/or control are required at multiple areas.

Although FIGS. 1-3 show a liner layer 10 with control panel 3 bonded with adhesive, the control panel 3 may be attached to the main panel 4 by any known method for forming fabric laminates (as explained above), including but not limited to a hot melt layer. The control and support afforded by the control panels on the liner layer may be augmented by other means of support such as underwires and foam pads. The edges of the liner layer 10 and the edges of the outer layer of the garment may be bonded together to permit hidden support or control while keeping a smooth exterior appearance and softness of the outer layer.

The outer layers of garments according to the present invention may be fabricated from warp knitted fabrics such as nylon and polybutylene terephthalate (PBT), and also from weft knitted and spandex fabrics. Main panel 4 may be fabricated from warp knitted fabrics such as nylon and polyester, and from weft knitted fabrics, single jersey, and spandex fabrics. Control liners may be formed from knitted fabrics such as nylon and polyester, and weft knitted fabrics, single jersey, and spandex fabrics. However, the materials of the outer layers, main panels, and control liners are not limited to the above fabrics.

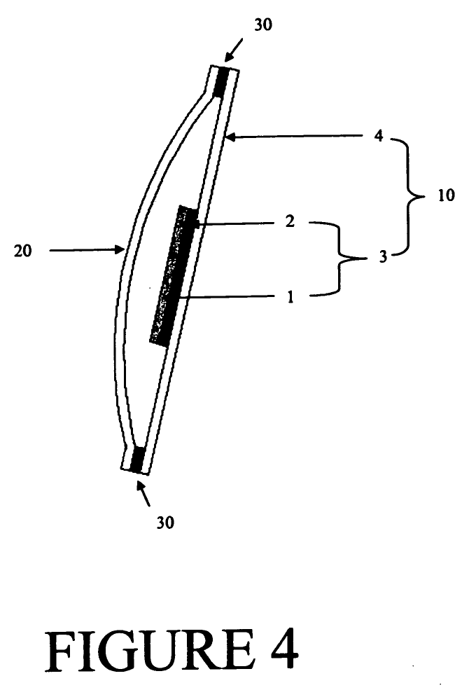

FIG. 4 shows a cross-section of a garment according to the present invention. Control liner 1 is shown bound to main panel 4 by adhesive 2 to form liner layer 10. As an alternative, control liner 1 and main panel 4 may be bound by other methods, e.g., hot melt to form liner layer 10. The edges of liner layer 10 may then be attached to the edges of outer layer 20 of the garment by adhesive 30. Alternative methods of attaching the edges of liner layer 10 to the edges of outer layer 20 include, but are not limited to, hot melt and sewing. Attaching the edges of liner layer 10 and outer layer 20 in this way allows the outer layer 20 of the garment to “float” over the liner layer 10.

The principles, preferred embodiments, and modes of operation of the present invention have been described in the foregoing specification. The invention should not, however, be construed as limited to the particular forms disclosed, as these are to be regarded as illustrative rather than restrictive. Variations and changes may be made by those skilled in the art without departing from the spirit of the present invention. Accordingly, the foregoing best mode of carrying out the invention should be considered exemplary in nature and not as limiting to the scope and spirit of the invention as set forth in the appended claims.

What is claimed is:

1. A method of fabricating a garment comprising:
cutting a pattern from a fabric to create the outer layer of a garment, the outer layer having an exterior edge;
cutting a pattern from a second fabric to create a control liner;
cutting a pattern from a third fabric to create a main panel;
bonding the control liner to the main panel to create a liner layer, the liner layer having exterior edges; and
attaching the exterior edge of the liner layer to the exterior edge of the outer layer to form a garment having a hidden control liner.

2. The method of claim 1, wherein the outer layer is substantially free of the liner layer.

3. The method of claim 1, wherein the bonding comprises using an adhesive.

4. The method of claim 1, wherein the bonding comprises using a hot melt adhesive.

5. The method of claim 1, wherein a portion of the liner layer within the exterior edge of the liner layer is capable of sliding with respect to a portion of the outer layer within the exterior edge of the outer layer.

6. The method of claim 1, wherein the portion of the liner layer to which the control liner is bonded provides more support to the body of a person wearing the garment than the remainder of the liner layer, and the location of the control liner is not visible on a surface of the outer layer facing away from the liner layer.

7. The method of claim 1, wherein the bonding comprises heat pressing.

8. The method of claim 1, wherein the bonding comprises ultrasonic bonding.

9. The method of claim 1, wherein the cutting is done ultrasonically.

10. The method of claim 3, wherein the adhesive is thermoplastic.

11. The method of claim 3, wherein the adhesive is thermosetting.

12. A garment comprising:
a control panel;
a main panel; and
an outer layer having exterior edges;
wherein the control panel is bonded to the main panel in specified areas to form a liner layer having localized support, the liner layer having exterior edges, and the liner layer is attached to the outer layer at the exterior edges of the liner layer and outer layer.

13. The garment of claim 12, wherein a portion of the liner layer within the exterior edges of the liner layer is capable of sliding with respect to a portion of the outer layer within the exterior edges of the outer layer.

14. The garment of claim 12, wherein the control panel is located at the exterior edges of the liner layer.

15. The garment of claim 12, wherein a plurality of control panels are bonded to the main panel, each at a different area of the main panel.

16. The garment of claim 12, wherein the control panel is bonded to the main panel using an adhesive.

17. The garment of claim 16, wherein the adhesive is a hot melt adhesive.

18. The garment of claim 12, wherein the portion of the liner layer to which the control liner is bonded provides more support to the body of a person wearing the garment than the remainder of the liner layer, and the location of the control liner is not visible on a surface of the outer layer facing away from the liner layer.

19. The garment of claim 16, wherein the adhesive is thermoplastic.

20. The garment of claim 16, wherein the adhesive is thermosetting.
